(19) United States
(12) Patent Application Publication
(10) Pub. No.: US 2011/0131063 A1
(43) Pub. Date: Jun. 2, 2011

(54) METHOD OF GENERATING FINANCING

(76) Inventor: Donald H. Skelton, Bonita Springs, FL (US)

(21) Appl. No.: 12/629,189

(22) Filed: Dec. 2, 2009

(51) Int. Cl. G06Q 40/00

(52) U.S. Cl. 705/4; 705/37

(57) ABSTRACT

A method of generating financing comprising selecting a group of private investors and pairing them with an investment grade irrevocable guarantor program. The method includes obtaining a government agreement to cover the irrevocable guarantee in exchange for purchasing a benefit settlement wrap to offset the irrevocable guarantee, if needed. Providing a business with investment funds from said investment grade irrevocable guarantor program and paying investors a profit from sale of said benefit settlement wrap if said business succeeds. Covering said irrevocable guarantee from the same of said benefit wrap if said business fails.

### TECHNICAL FIELD

The present invention relates generally to a method of generating financing and more particular to a method of generating irrevocable guarantor financing for start-up and entrepreneurial companies.

### BACKGROUND OF THE INVENTION

It is recognizes that the economy of any free market driven society will have to weather periods of time when the money flow, job market, and growth may suffer or stagnate. The melt-down of financial institutions may significantly impact the available credit upon which both businesses and individuals rely. This is especially true of start-up and entrepreneurial companies needing capital to begin a business or expand a business. It tight economic times it is common for credit to be unavailable to these at-risk companies in traditional fashion.

It is known, however, that the success of these start-up and entrepreneurial companies can have the benefit of increasing the tax base and providing needed employment. Traditional venture capital sources are reasonably reticent to assume the risk involved in these fledgling companies. Therefore, venture capitalists often require the upstart companies to provide irrevocable guarantees on money loaned to them. These irrevocable guarantees are unavailable to many such start ups. Thus a significant impediment stands between the production of jobs and taxes that will stir the economy and the fact that investors are unlikely to take significant risks particularly in a depressed economy.

It would therefore be highly beneficial to have a method of generating financing in a depressed economy that would encourage the investment of venture capitalists in start up or entrepreneurial companies by way of ameliorating at least a portion of the financial risk they face when investing money.

### SUMMARY OF THE INVENTION

In accordance with the objects of the present invention, a method of generating financing is provided. The method comprises selecting a group of private investors and pairing them with an investment grade irrevocable guarantor program. The method includes obtaining a government agreement to cover the irrevocable guarantee in exchange for purchasing a benefit settlement wrap to offset the irrevocable guarantee if needed, providing a business with investment funds from said investment grade irrevocable guarantor program. Paying investors a profit from sale of said benefit settlement wrap if said business succeeds, and covering said irrevocable guarantee from the same of said benefit wrap if said business fails.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an embodiment of a method of generating financing in accordance with the present invention.

FIG. 2 is an illustration of an alternate embodiment of a method of generating financing in accordance with the present invention.

### DESCRIPTION OF PREFERRED EMBODIMENTS

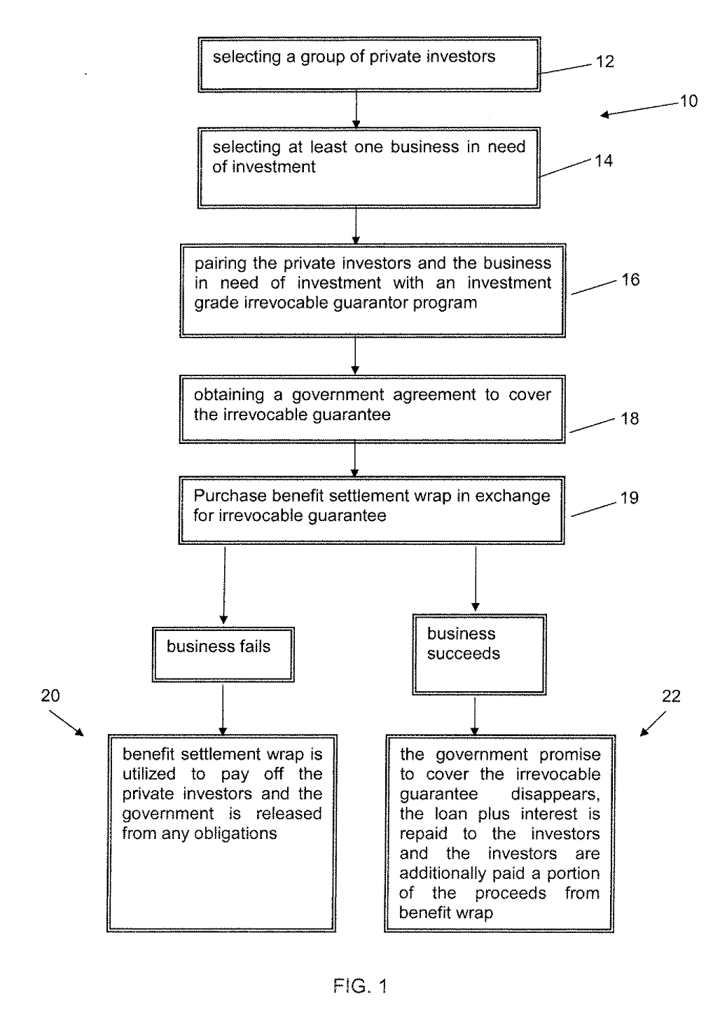

The present invention provides a method of generating financing 10 as illustrated in FIG. 1. The method of generating financing 10 is preferably directed towards generating financing for start up or entrepreneurial companies, although a variety of investment opportunities will be obvious in light of the present disclosure. The present invention generates financing 10 by selecting a group of private investors 12. It should be understood that the term “group of private investors” is intended to encompass a wide variety of fund sources, including such groups as investment funds.

The present invention then selects one or more businesses in need of investment 14. It is contemplated that this may include selecting from a pool of potential businesses which have applied for funding from an organization utilizing the present invention. The present invention seeks to provide money from the private investors to businesses in need of investment. This is accomplished by way of pairing the private investors and the business (or businesses) in need of investment with an investment grade irrevocable guarantor program (IGIG) 16. The IGIG program provides at least one business with access to funding from the private investors. The IGIG preferably provides the business with a low interest rate loan with deferred interest and principle payments for a period of time. In one embodiment, the period of time is contemplated to be less than five years. In another embodiment it is contemplated to be less than three years. At the end of this period, the business would be required to repay the loan with the compounded interest. Although several repayment options have been discussed, the present invention contemplates a variety of creative repayment options. The advantages of this form of loan is that it allows small start ups, entrepreneurs, and expanding businesses to start and obtain profitability prior to having to make payments on the business loan.

It is understood that the formation or expansion of these businesses can carry with it a risk for any investor. For this reason, the IGIG requires a irrevocable guarantee that the loan will be repaid in full with interest. Without such a guarantee, most private investors are unwilling to place their venture capital at risk. The start ups and entrepreneurial businesses in need of this venture capital are commonly not in a position to make such a guarantee as they are often not up and running and seldom profitable at the point of loan origination.

The present invention therefore proposes obtaining a government agreement (or organizational agreement) to cover the irrevocable guarantee 18. This agreement does not require actual monetary funds to be expended by the government, but rather acts as an insurance policy similar to the Federal Deposit Insurance Corporation insuring bank deposits. It is understood that the government would be reluctant to make such a guarantee, particularly as taxpayer money may be required to bail out investors from failed businesses. In accordance with the present invention, however, a government agreement can be obtained to cover the irrevocable guarantee in exchange for purchasing a benefit settlement wrap to offset the irrevocable guarantee if needed 19. In this fashion, the risk of loss is removed from the government by way of the insurance policy generated by the benefit settlement wrap.

Although the present invention contemplates the use of a Federal guarantee program, the present invention also contemplates guarantees from a state, county, or local city level since they commonly have bond and tax revenues able to support a guarantee. In addition, the present invention contemplates that large financial institutions may be able to support such a guarantee in exchange for a percentage of profits. As will be explained, this allows such financial institutions to provide a guarantee at virtually no risk while providing a profit. When a reasonably sized group of business are invested in a percentage of potential profits may benefit low risk investment funds.

The present invention contemplates the use of a variety of benefit settlement wraps. In one embodiment, the present invention contemplates the use of senior life settlement (SLS) wraps. SLS wraps are groups of senior life insurance policies purchased from seniors who need or want the money from their policies while they are still alive. The wrap purchases these insurance polices for a percentage of the end payout value and assumes premium payments. By properly selecting individual policies and grouping them in sufficient quantities, a wrap can be organized into a relatively risk free investment. Although SLSs are the preferred embodiment, the present invention contemplates the use of other similar benefits such as lottery buyouts or other guaranteed future payment purchases where a guaranteed end value may be purchased in advance for a percentage of its end value.

The benefit settlement wrap is preferably purchased by the business to be receiving the investment funds. It is contemplated that the purchase value may be included in the original loan amount provided by the IGIG program. If the business fails, the government as guarantor of the irrevocable guarantee would normally be responsible to repay the private investors for their losses. The advantage of the claimed arrangement is that if the business fails, the benefit settlement wrap is utilized to pay off the private investors. At the same time, the government is released from any obligations 20. In this fashion, the government's financial strength is utilized as a backing for business loans vital to stirring the economy while actual government funds, and thereby the taxpayer, are protected.

If, on the other hand, the business is a success, the government promise to cover the irrevocable guarantee disappears, the loan plus interest is repaid to the investors and the investors are additionally paid a portion of the proceeds from benefit wrap 22. This provides additional incentives to private investors in addition to a guaranteed return on their investment.

The present invention provides a unique way for the government to take a role in jump-starting a struggling economy without incurring a financial burden or risking taxpayer money. Since there is a significant positive benefit to the private sector and no financial risk or payment obligation to the government, the present methodology is likely to garner significant political support. This will facilitate the flow of investment cash from private investors to start up companies which will in turn result in an increased employment rate and an increased tax base for the government. Businesses will thrive by receiving financing without a credit committee review or financial maintenance covenants.

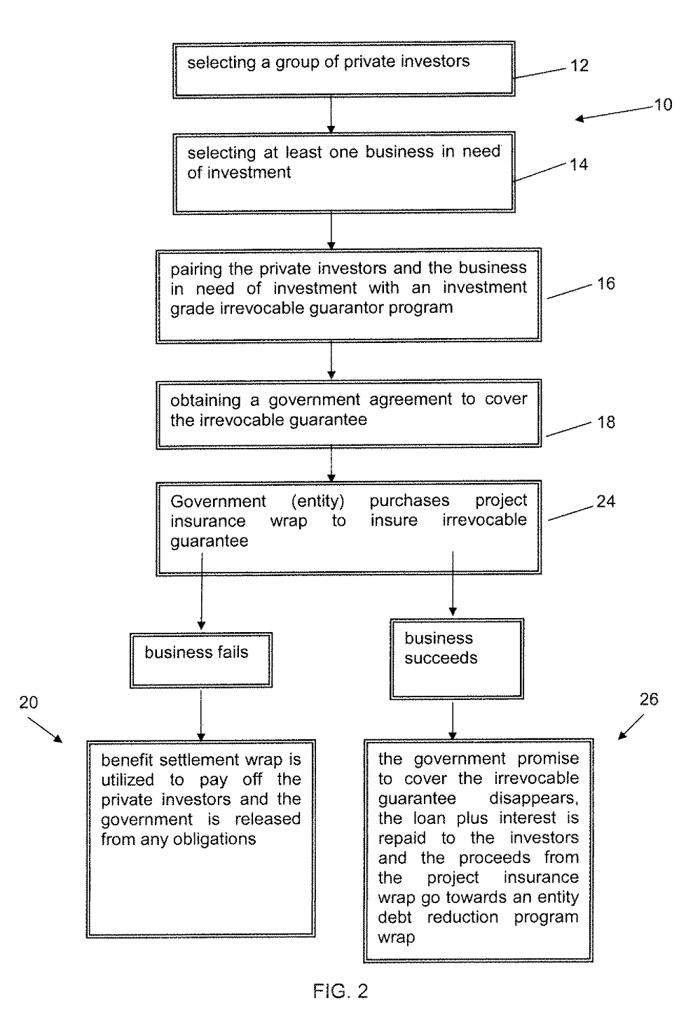

In an alternate arrangement, it is contemplated that the government could purchase the settlement wrap as the insurance on the guarantee 24 (see FIG. 2). In this case if the business is successful the profits go towards a debt reduction program 26 wherein the wrap proceeds go to the treasury of the entity providing the wrap. This arrangement could be combined with the private financing arrangement such that a private party government partnership is formed and both parties participate in the wrap and the resultant profits.

An advantage of the present invention is the ability to quantify the jobs created by the private sector being funded. This allows politicians to take credit for a program that bolsters employment for their constituents and yet limits or eliminates any cost to the government in the event a project fails. The politicians and government will benefit from job creation, new taxes, and political popularity as the projects receiving the guaranteed funds achieve their target goals.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A method of generating financing comprising:
selecting a group of private investors;
selecting at least one business in need of investment;
pairing said private investors and said at least one business with an investment grade irrevocable guarantor program;
obtaining a government agreement to cover the irrevocable guarantee in exchange for purchasing a benefit settlement wrap to offset the irrevocable guarantee if needed;
providing a business with investment funds from said investment grade irrevocable guarantor program;
paying investors a profit from sale of said benefit settlement wrap if said business succeeds; and
covering said irrevocable guarantee for the government from the same of said benefit wrap if said business fails.

2. The method as described in claim 1, wherein said benefit settlement wrap is purchased by said business.

3. The method as described in claim 1, wherein said investors purchase said benefit settlement wrap.

4. The method as described in claim 1, wherein said benefit settlement wrap is purchased by said comprises a senior life settlement wrap.

5. The method as described in claim 1, wherein said benefit settlement wrap comprises a project insurance wrap.

6. The method as described in claim 1, wherein said step of providing a business with investment funds comprises providing a loan at less than 10 percent interest with deferred interest and principle payments for up to 5 years.

7. A method of generating financing comprising:
selecting a group of private investors;
selecting at least one business in need of investment;
pairing said private investors and said at least one business with an investment grade irrevocable guarantor program;
obtaining an entity agreement to cover the irrevocable guarantee;
having said entity purchase a benefit settlement wrap to offset the irrevocable guarantee if needed;
providing a business with investment funds from said investment grade irrevocable guarantor program;
paying said entity a profit from sale of said benefit settlement wrap if said business succeeds; and
covering said irrevocable guarantee for the entity from the same of said benefit wrap if said business fails.

8. A method as described in claim 7, wherein said entity comprises the Federal Government.

9. A method as described in claim 7, wherein said entity comprises a local governmental entity.

10. A method as described in claim 7, wherein said private investors and said entity both participate in the purchase of the benefit settlement wrap; and
both said private investors and said entity both participate in profits from the sale of said benefit settlement wrap if said business succeeds.

11. The method as described in claim 7, wherein said benefit settlement wrap is purchased by said comprises a senior life settlement wrap.

12. The method as described in claim 7, wherein said benefit settlement wrap comprises a project insurance wrap.

13. The method as described in claim 7, wherein said step of providing a business with investment funds comprises providing a loan at less than 10 percent interest with deferred interest and principle payments for up to 3 years.
